(19) United States
(12) Patent Application Publication
(10) Pub. No.: US 2014/0000078 A1
(43) Pub. Date: Jan. 2, 2014

(54) METHOD FOR MANUFACTURING IMPELLER ASSEMBLY OF COOLING FAN

(71) Applicants: MING-HSIU CHUNG, Tu-Chengi (TW); YU-KAI TAI, Tu-Cheng (TW)

(72) Inventors: MING-HSIU CHUNG, Tu-Chengi (TW); YU-KAI TAI, Tu-Cheng (TW)

(21) Appl. No.: 13/660,021

(22) Filed: Oct. 25, 2012

(30) Foreign Application Priority Data
Jun. 29, 2012 (TW) 101123553

(51) Int. Cl. B23P 17/00

(52) U.S. Cl. 29/407.01

(57) ABSTRACT

An exemplary method for manufactured an impeller assembly of a cooling fan includes following steps: providing an impeller, the impeller comprising a plurality of blades and a hub, the blades formed on an outer periphery of the hub; testing a center of gravity of the impeller; providing a shaft and fixing one end of the shaft in the center of gravity of the impeller.

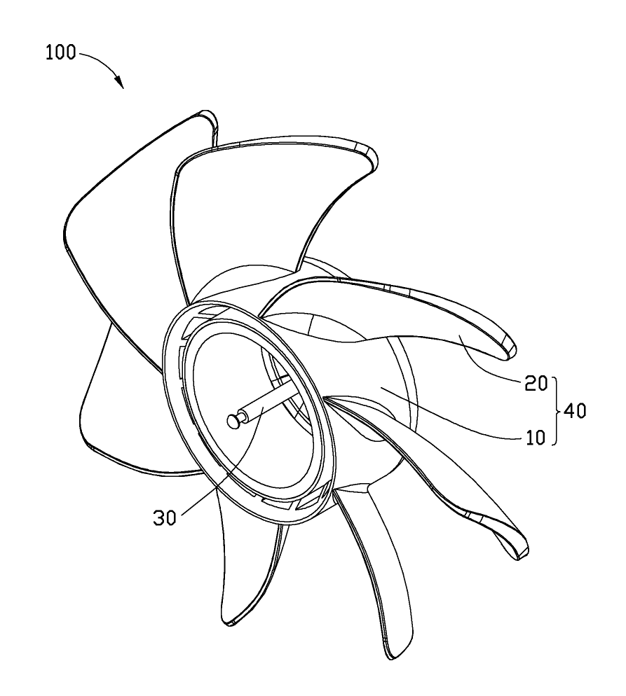

### BACKGROUND

1. Technical Field

The disclosure generally relates to cooling fans, and more particularly to a method for manufacturing an impeller assembly of a cooling fan.

2. Description of Related Art

A plurality types of cooling fans is used to cool heat generating components. A conventionally cooling fan includes a cover and an impeller assembly received in the cover. When the impeller assembly is manufactured, a plurality of balance holes is predetermined defined in blades of the impeller, a fan balancing mainframe is provided to test a balance of the impeller, and then a plurality of adjusting powder is inserted in the balance holes to adjust the balance of the impeller assembly according to the tested conclusion to avoid vibration. However, the manufacturing processes of the impeller are time-consuming and costly requirement.

What is needed, therefore, is a method for manufacturing an impeller assembly to overcome the above described shortcomings.

### BRIEF DESCRIPTION OF THE DRAWINGS

The figure is an isometric, assembled view of an impeller assembly of an exemplary embodiment of the present disclosure.

### DETAILED DESCRIPTION

Referring to the figure, an impeller assembly 100 of an exemplary embodiment of the present disclosure includes an impeller 40 and a shaft 30 fixed on the impeller 40. The impeller 40 includes a hub 10 and a plurality of blades 20 integrally formed on an outer periphery of the hub 10. The shaft 30 is fixed on the hub 10.

A method for manufactured the impeller assembly 100 includes following steps.

The impeller 40 is provided. The impeller 40 includes the blades 20 and the hub 10. The blades 20 are formed on the outer periphery of the hub 10. The blades 20 and the hub 10 are integrally formed as a single piece.

A center of gravity of the impeller 40 is tested. In this embodiment, a fan balancing main frame is provided to test the center of gravity of the impeller 40. The fan balance main frame includes an optical sensor, a balance plate, a vibration sensor, and a mainframe. The impeller 40 is fixed on the balance plate. The optical sensor measures revolutions per minute and phase of the blades 20. The vibration sensor measures a vibration caused by the blades 20. The mainframe analyzes the vibration caused by the blades 20.

The shaft 30 is provided, and one end of the shaft 30 is fixed on the center of gravity of the impeller 40. The end of the shaft 30 is inserted in the hub 10 and fixed on the hub 10 by riveting or laser.

In this disclosure, before the shaft 30 is fixed in the impeller 40, the center of gravity of the impeller 40 is tested. Thus, processes of defining the balance holes in the blades and inserting adjusting powder in the balance holes of the method for manufacturing the conventionally impeller assembly are omitted. Therefore, time and cost for manufacturing the impeller assembly 100 of the present disclosure are reduced.

It is to be further understood that even though numerous characteristics and advantages of the present embodiments have been set forth in the foregoing description, together with details of the structures and functions of the embodiments, the disclosure is illustrative only, and changes may be made in detail, especially in matters of shape, size, and arrangement of parts within the principles of the disclosure to the full extent indicated by the broad general meaning of the terms in which the appended claims are expressed.

What is claimed is:

1. A method for manufacturing an impeller assembly of a cooling fan comprising following steps:
providing an impeller, the impeller comprising a plurality of blades and a hub, the blades formed on an outer periphery of the hub;
testing a center of gravity of the impeller;
providing a shaft and fixing one end of the shaft in the center of gravity of the impeller.

2. The method of claim 1, wherein the blades and the hub are integrally formed as a single piece.

3. The method of claim 1, wherein one end of the shaft is inserted in the hub and fixed on the hub.

4. The method of claim 3, wherein the shaft and the hub are fixed together by riveting or laser.

5. A method for manufacturing an impeller of a cooling fan comprising following steps:
providing an impeller, the impeller comprising a plurality of blades and a hub, the blades formed on an outer periphery of the hub;
testing a center of gravity of the impeller;
providing a shaft, inserting one end of the shaft in the hub and fixing the shaft on the hub to make the shaft be fixed on the center of gravity of the impeller.

6. The method of claim 5, wherein the blades and the hub are integrally formed as a single piece.

7. The method of claim 5, wherein the shaft and the hub are fixed together by riveting or laser.
